(19) United States
(12) Patent Application Publication
(10) Pub. No.: US 2008/0091503 A1
(43) Pub. Date: Apr. 17, 2008

(54) E-MEETING PREPARATION MANAGEMENT

(75) Inventors: Andrew L. Schirmer, Andover, MA (US); Michael Muller, Medford, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/548,393

(22) Filed: Oct. 11, 2006

(51) Int. Cl. G06F 15/02

(52) U.S. Cl. 705/9

(57) ABSTRACT

Embodiments of the present invention address deficiencies of the art in respect to e-meeting scheduling and provide a method, system and computer program product for e-meeting preparation in a calendaring and scheduling system. In one embodiment of the invention, a method for e-meeting preparation in a calendaring and scheduling system can include establishing an e-meeting for one or more invitees. The method further can include specifying when to provide a confirmation for the e-meeting as part of a default policy in the calendaring and scheduling system. The method further can include providing a materials distribution for the e-meeting confirmation to at least one of the invitees according to the configuration specific to the e-meeting. Finally, the method can include providing an e-meeting confirmation to at least one of the invitees according to the default policy.

### BACKGROUND OF THE INVENTION

1. Field of the Invention

The present invention relates to the field of collaborative computing and more particularly to scheduling e-meetings in a collaborative computing environment.

2. Description of the Related Art

Individuals worldwide can converge over a communications network to share ideas, documents, sound and images without needing to be in the same room. Technology facilitates this through multipoint audio conferencing, video conferencing over traditional networks, and many forms of conferencing over the Internet. A substantial collection of technologies and protocols has been assembled to effectively deliver audio, video, and data over the single digital communications medium of the Internet.

An e-meeting represents one popular form of electronic collaboration. In an e-meeting, participants can view a common space, for instance a whiteboard or a shared application (or both), through which ideas can be exchanged. The viewing of the common space can be complemented with a teleconference, a videoconference, an instant messaging session, or any combination thereof, such that the meeting can act as a near substitute for an in-person meeting in a conference room.

Collaborators who participate in e-meetings often maintain a personal schedule managed by a scheduling system. Collaborators can schedule e-meetings within the personal schedule sua sponte, or the collaborators can schedule e-meetings responsive to the receipt of an invitation. An invitation typically contains data regarding the e-meeting such as a topic, list of invitees, and most importantly, a date, time and location for the e-meeting. Using this data, the invitee can be prompted either to accept or decline the invitation. Oftentimes, the acceptance or declination of an invitation can be accomplished with a single user action such as a mouse click.

Once an e-meeting has been scheduled and the selected participants notified, prior to the scheduled occurrence of the e-meeting one or more e-meeting confirmations can be issued to the selected participants who have accepted the originally issued invitation. Traditionally, an e-meeting confirmation is an e-mail reminder provided by the e-meeting organizer and transmitted manually to the selected participants. Of course, the successful transmission of an e-meeting confirmation depends entirely upon the e-meeting organizer remembering to draft and send the e-meeting confirmation.

Oftentimes, in order to prepare for a scheduled e-meeting, it can be helpful to distribute e-meeting materials in advance of the scheduled e-meeting. Those materials can include e-meeting agenda materials, an advance copy of a presentation to be delivered at the e-meeting, and the like. As in the case of the e-meeting confirmation, traditionally, the e-meeting organizer can transmit an e-mail to the selected participants along with attached documents representative of the e-meeting materials. As before, the successful transmission of an e-meeting materials depends entirely upon the e-meeting organizer remembering to attach the materials to an e-mail and to send the e-mail to the selected participants.

### BRIEF SUMMARY OF THE INVENTION

Embodiments of the present invention address deficiencies of the art in respect to e-meeting scheduling and provide a novel and non-obvious method, system and computer program product for e-meeting preparation in a calendaring and scheduling system. In one embodiment of the invention, a method for e-meeting preparation in a calendaring and scheduling system can include establishing an e-meeting for one or more invitees. The method further can include specifying when to provide a confirmation for the e-meeting as part of a default policy in the calendaring and scheduling system. Finally, the method can include providing an e-meeting confirmation to at least one of the invitees according to the default policy.

Optionally, in one aspect of the embodiment, the method further can include specifying when to provide an invitation to the e-meeting as part of a default policy in the calendaring and scheduling system, providing an e-meeting invitation to the invitees according to the default policy. Similarly, the method yet further can include specifying when to provide a materials distribution for the e-meeting as part of a default policy in the calendaring and scheduling system, and providing a materials distribution for the e-meeting confirmation to at least one of the invitees according to the defauk policy. In any event, providing an e-meeting confirmation to at least one of the invitees according to the default policy can include providing an e-meeting confirmation to at least one of the invitees utilizing a specified mode of communication selected from the group consisting of an e-mail, an instant message and a short message service message according to the default policy.

Optionally, as another aspect of the embodiment, the method further can include overriding the default policy for the e-meeting with a configuration specific to the e-meeting, and providing an e-meeting confirmation to at least one of the invitees according to the configuration specific to the e-meeting. Likewise, the method yet further can include providing an e-meeting invitation to the invitees according to the configuration specific to the e-meeting. Finally, the method yet further can include providing a materials distribution for the e-meeting confirmation to at least one of the invitees according to the configuration specific to the e-meeting.

In another embodiment of the invention, a calendaring and scheduling data processing system can be provided. The system can include a calendaring and scheduling host, an e-meeting scheduling application coupled to the host, and and e-meeting preparation management logic. The logic can include program code enabled to specify when to provide an e-meeting invitation, an e-meeting confirmation, and an e-meeting materials distribution for an e-meeting as part of one of a default policy for all e-meetings and a specific configuration for the e-meeting. Notably, the host can be centralized in a single computing device, distributed amongst multiple computing devices, or disposed among peers to the e-meeting scheduling application.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a calendaring and scheduling data processing system configured for e-meeting preparation management;

FIG. 2 is a block diagram illustrating an architecture for an e-meeting application configured for e-meeting preparation management; and,

FIG. 3 is a flow chart illustrating a process for e-meeting preparation management.

### DETAILED DESCRIPTION OF THE INVENTION

Embodiments of the present invention provide a method, system and computer program product for e-meeting preparation management. In accordance with an embodiment of the present invention, an established e-meeting can be enabled for automated invitation, confirmation and materials distribution. In this regard, once an e-meeting has been established, an invitation automatically can be forwarded to the invitees for the e-meeting. Similarly, at a specified time prior to the e-meeting, an e-meeting confirmation can be automatically generated and forwarded to selected ones of the invitees to the e-meeting. Finally, materials requisite to the e-meeting automatically can be located and distributed to selected ones of the invitees to the e-meeting prior to the e-meeting. In this way, the e-meeting organizer need not manually engage in the preparation activities of e-meeting invitation, confirmation and materials distribution for the e-meeting.

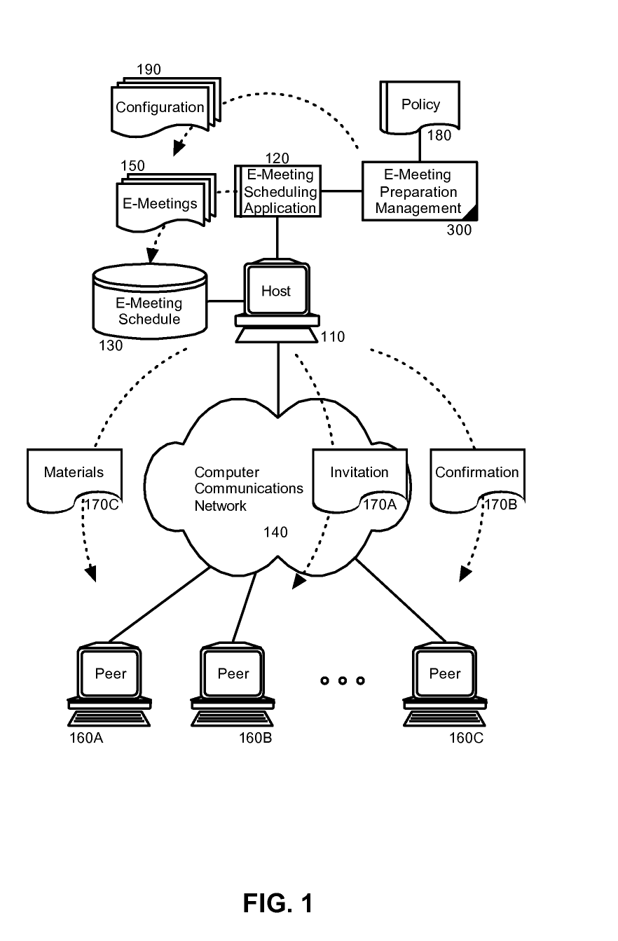

In illustration, FIG. 1 is a schematic illustration of a calendaring and scheduling data processing system configured for e-meeting preparation management. As shown in FIG. 1, a calendaring and scheduling system can include a calendaring and scheduling host 110 coupled to one or more calendaring and scheduling peers 160A, 160B, 160C over a computer communications network 140. The calendaring and scheduling host 110 can be configured to support the calendaring and scheduling of events amongst the peers 160A, 160B, 160C. The schedulable events for the calendaring and scheduling host 110 can include e-meetings. Notably, though the illustration of FIG. 1 shows a centralized calendaring and scheduling system supporting the peers 160A, 160B, 160C, the skilled artisan will recognize that the logic of the calendaring and scheduling system equivalently can be disposed among the peers 160A, 160B, 160C, distributed among many calendaring and scheduling hosts, or shared between one or more calendaring and scheduling hosts and the peers 160A, 160B, 160C.

The calendaring and scheduling host 110 can be coupled to an e-meeting scheduling application 120. The e-meeting scheduling application 120 can be configured to support the scheduling of e-meetings 150 in an e-meeting schedule 130 by one or more of the peers 160A, 160B, 160C either for individual meetings, or recurring instances of a meeting. Importantly, e-meeting preparation management logic 300 further can be coupled to the e-meeting scheduling application 120. The e-meeting preparation management logic 300 can include program code enabled to automatically perform e-meeting invitation, confirmation and materials distribution based upon either a policy 180 dictating when and to whom an e-meeting invitation 170A, e-meeting confirmation 170B, or e-meeting materials distribution 170C is provided, or an e-meeting specific configuration 190 dictating the same. The e-meeting invitation, confirmation and materials distribution can be performed through separate messaging tools, for example e-mail, instant messaging, short message services, and the like.

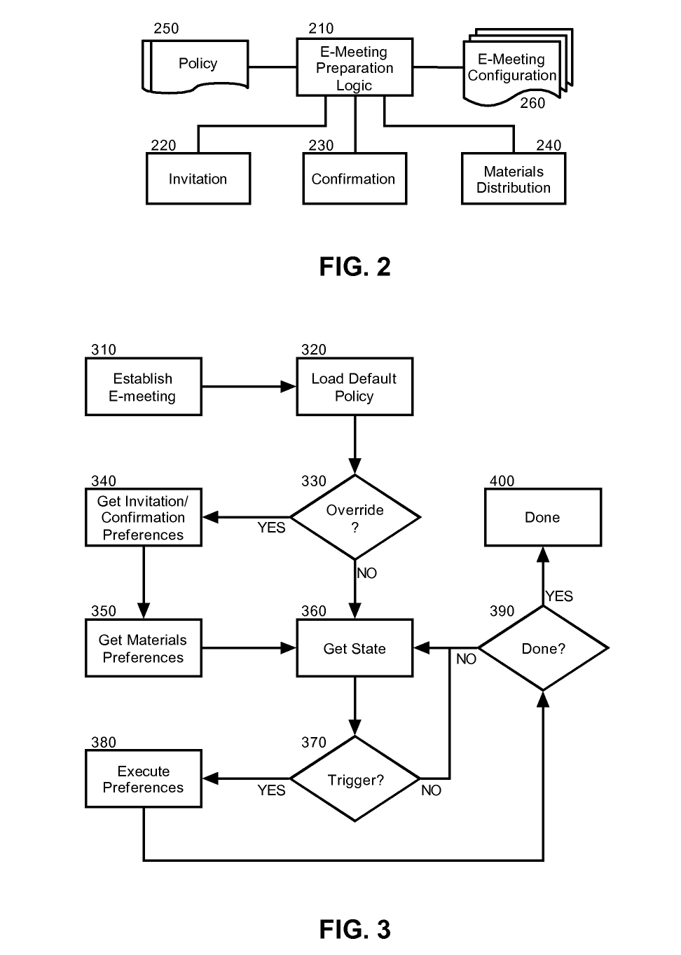

In more particular illustration, FIG. 2 is a block diagram illustrating an architecture for an e-meeting application configured for e-meeting preparation management. As shown in FIG. 2, e-meeting preparation logic 210 can include invitation logic 220, confirmation logic 230 and materials distribution logic 240. The e-meeting preparation logic 210 further can be coupled to an e-meeting preparation policy 250, and e-meeting preparation configurations 260 corresponding to established e-meetings. Each of the invitation logic 220, confirmation logic 230 and the materials distribution logic 240 can determine when to automatically provide e-meeting invitations, e-meeting confirmations and e-meeting materials distributions, respectively, based upon the rules specified by the policy 250 unless overridden by the rules specified for a particular e-meeting in an associated e-meeting configuration 260. Similarly, both the policy 250 and the e-meeting configuration 260 can specify the mode of providing invitations, confirmations and materials distribution, including e-mail, instant messaging, and short message services.

The invitation logic 220 can include program code enabled to determine when to automatically forward an e-meeting invitation to a selected group of invitees subsequent to the establishment of an e-meeting. Generally, some lapse of time can be provided for either in the policy 250, or in a specific e-meeting configuration 260 in order to allow the e-meeting organizer to confirm the suitability of the proposed e-meeting time. Similarly, the confirmation logic 230 can include program code enabled to determine when to automatically forward an e-meeting confirmation to one or more of the invitees subsequent to the invitees receiving invitations to the e-meeting. For example, all of the invitees can receive a confirmation, or only those invitees who have accepted the invitation can receive the confirmation.

Finally, the materials distribution logic 240 can include program code enabled to determine when to automatically forward e-meeting materials pertinent to the e-meeting to one or more of the invitees prior to the scheduled e-meeting. In this regard, the program code of the materials distribution logic 240 can be enabled to retrieve from a specified location or locations one or more files which can be provided to selected ones of the invitees. In this way, the e-meeting organizer can store and modify requisite e-meeting materials in a location knowing that the materials will automatically be forwarded to one or more designated ones of the invitees, but not before a specified time prior to the e-meeting.

In yet further illustration of the operation of the program code of the e-meeting preparation logic, FIG. 3 is a flow chart illustrating a process for e-meeting preparation management. Beginning in block 310, an e-meeting can be established. In block 320, a default policy can be loaded for e-meeting preparation. In block 330, it can be determined if the established e-meeting has been associated with e-meeting preparation preferences specific to the established e-meeting. If not, the process can proceed through block 360. Otherwise, the process can proceed through block 240.

In block 340, the invitation and confirmation preferences can be retrieved for the established e-meeting. Those preferences can include a determination of when to provide an e-meeting invitation to designated invitees, and when, how often and to whom to provide e-meeting confirmations for the established e-meeting. The preferences yet further can specify the mode of providing e-meeting invitations and confirmations. In block 350, materials distribution preferences specific to the established e-meeting similarly can be retrieved. Thereafter, in block 360, the state of the established e-meeting can be determined, for example the amount of time that has elapsed since the establishment of the e-meeting, and the amount of time remaining until the occurrence of the e-meeting.

In decision block 370, if it is determined that either an invitation, confirmation or materials distribution is to occur based upon the state, in block 380 an e-meeting invitation, confirmation or materials distribution can be performed depending upon the determined state and according to the retrieved preferences. Subsequently, in decision block 390, if the e-meeting has occurred, in block 400 the process can end. Otherwise, the process can repeat through block 360.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for e-meeting preparation in a calendaring and scheduling system, the method comprising:
establishing an e-meeting for a plurality of invitees;
specifying when to provide a confirmation for the e-meeting as part of a default policy in the calendaring and scheduling system; and,
providing an e-meeting confirmation to at least one of the invitees according to the default policy.

2. The method of claim 1, further comprising:
specifying when to provide an invitation to the e-meeting as part of a default policy in the calendaring and scheduling system; and,
providing an e-meeting invitation to the invitees according to the default policy

3. The method of claim 1, further comprising:
specifying when to provide a materials distribution for the e-meeting as part of a default policy in the calendaring and scheduling system; and,
providing a materials distribution for the e-meeting confirmation to at least one of the invitees according to the default policy.

4. The method of claim 1, wherein providing an e-meeting confirmation to at least one of the invitees according to the default policy, comprises providing an e-meeting confirmation to at least one of the invitees utilizing a specified mode of communication selected from the group consisting of an e-mail, an instant message and a short message service message according to the default policy.

5. The method of claim 1, further comprising:
overriding the default policy for the e-meeting with a configuration specific to the e-meeting; and,
providing an e-meeting confirmation to at least one of the invitees according to the configuration specific to the e-meeting.

6. The method of claim 5, further comprising providing an e-meeting invitation to the invitees according to the configuration specific to the e-meeting

7. The method of claim 5, further comprising providing a materials distribution for the e-meeting confirmation to at least one of the invitees according to the configuration specific to the e-meeting.

8. A calendaring and scheduling data processing system comprising:
a calendaring and scheduling host;
an e-meeting scheduling application coupled to the host; and,
e-meeting preparation management logic comprising program code enabled to specify when to provide an e-meeting invitation, an e-meeting confirmation, and an e-meeting materials distribution for an e-meeting as part of one of a default policy for all e-meetings and a specific configuration for the e-meeting.

9. The system of claim 8, wherein the calendaring and scheduling host is centralized in a single computing device.

10. The system of claim 8, wherein the calendaring and scheduling host is distributed amongst multiple computing devices.

11. The system of claim 8, wherein the calendaring and scheduling host is disposed among peers to the e-meeting scheduling application.

12. A computer program product comprising a computer usable medium having computer usable program code for e-meeting preparation in a calendaring and scheduling system, the computer program product including:
computer usable program code for establishing an e-meeting for a plurality of invitees;
computer usable program code for specifying when to provide a confirmation for the e-meeting as part of a default policy in the calendaring and scheduling system; and,
computer usable program code for providing an e-meeting confirmation to at least one of the invitees according to the default policy.

13. The computer program product of claim 12, further comprising:
computer usable program code for specifying when to provide an invitation to the e-meeting as part of a default policy in the calendaring and scheduling system; and,
computer usable program code for providing an e-meeting invitation to the invitees according to the default policy

14. The computer program product of claim 12, further comprising:
computer usable program code for specifying when to provide a materials distribution for the e-meeting as part of a default policy in the calendaring and scheduling system; and,
computer usable program code for providing a materials distribution for the e-meeting confirmation to at least one of the invitees according to the default policy.

15. The computer program product of claim 12, wherein the computer usable program code for providing an e-meeting confirmation to at least one of the invitees according to the default policy, comprises computer usable program code for providing an e-meeting confirmation to at least one of the invitees utilizing a specified mode of communication selected from the group consisting of an e-mail, an instant message and a short message service message according to the default policy.

16. The computer program product of claim 12, further comprising:
computer usable program code for overriding the default policy for the e-meeting with a configuration specific to the e-meeting; and,
computer usable program code for providing an e-meeting confirmation to at least one of the invitees according to the configuration specific to the e-meeting.

17. The computer program product of claim 16, further comprising computer usable program code for providing an e-meeting invitation to the invitees according to the configuration specific to the e-meeting

18. The computer program product of claim 16, further comprising computer usable program code for providing a materials distribution for the e-meeting confirmation to at least one of the invitees according to the configuration specific to the e-meeting.
